(19) United States
(12) Patent Application Publication
(10) Pub. No.: US 2008/0256761 A1
(43) Pub. Date: Oct. 23, 2008

(54) Cord Clip

(76) Inventor: Timothy Daniel Bukoski, Sherwood, OR (US)

Correspondence Address: DRAFTINGHOUSE P.C., 612 NW 20th Ave., #17, PORTLAND, OR, 97209, US

(21) Appl. No.: 11/738,217

(22) Filed: Apr. 20, 2007

(51) Int. Cl. H01R 13/58

(52) U.S. Cl. 24/129 R

(57) ABSTRACT

A multipurpose cord clip is configured to hold multiple cord segments in a fixed relation to one another, or to be used to hold a cord along a route. The multipurpose cord clip is not permanently fixed to a cord and is capable of use on a permanent structure or independent of a permanent structure.

### CROSS-REFERENCE TO RELATED APPLICATIONS

Not applicable.

### STATEMENT REGARDING FEDERALLY SPONSORED RESEARCH

Not applicable.

### REFERENCE TO SEQUENCE LISTING

Not applicable.

### FIELD OF THE INVENTION

The present invention relates to cord clips, and particularly to cord clips constructed to hold multiple cord segments. The present invention also relates to cord clips used for retaining cords in temporary or permanent routes.

### BACKGROUND OF THE INVENTION

One type of cord clip is typically found on the plug portion of an electrical wire attached to an appliance such as a vacuum cleaner. The purpose of the clip is to permit an appliance user to coil the cord—often around posts on the appliance—then clip the cord to itself in order to retain the cord in place on the appliance. Such clips have drawbacks in that they are attached to the cord to which the plug is attached, rendering them unusable on their own. They also only have one receptacle to receive a cord—and can therefore only hold one cord segment at a time.

Another type of cord clip is an adhesive backed clip used to hold a cord in a route. A route is generally a path over which a cord travels and can be along a floor, a wall, a ceiling, a combination of theses structures or along other structures. These cord clips are typically constructed so that each cord clip is capable of retaining only one cord segment and are placed along the route using the adhesive. The drawbacks of such cord clips is that they are only useful for routing a cord and the adhesive is either a one-time use or requires replacement if the clip is to be used again. These cord clips also require a structure to be attached to in order to be useful.

There are a variety of other cord clips which are constructed to perform the same, or similar, cord holding functions for routing a cord. Many of these are nailed or screwed into place on a structure and often require removing the nail or screw to insert or remove a cord from the clip. There are therefore disadvantages exhibited by current cord clips—namely, they are either permanently attached to a cord which severely limits their use, or they are useful only for routing a cord.

### BRIEF SUMMARY OF THE INVENTION

There is currently a need for a cord clip which can be used on a variety of cords, and hold more than one cord segment. There is also a need for a cord clip which can be used with or without a permanent structure to route a cord. There is a further need for a single cord clip which can perform both of the above unmet needs. The present invention overcomes the inability of prior cord clips to be independent of a specific cord, to retain multiple cord segments and to be useful for cord retaining and cord routing without requiring different cord clips.

Embodiments of the present invention meet the above needs, and others, by having a shape configured to retain multiple cord segments as well as configured to be attached to a permanent structure or to permit use of the inventive cord clip on a stake. The inventive cord clip can be used for any application where a cord needs to be retained to itself or to other cords, or where cords need to be retained along a route. Embodiments of the inventive cord clip have a first clamp portion, a second clamp portion, and a joining structure attached to the first clamp portion and the second clamp potion to hold the first clamp portion in an angular relationship to the second clamp portion. Alternate embodiments of the inventive cord clip have additional clamp portions attached to the joining structure.

In certain embodiments, the first clamp portion comprises a first generally U-shaped member having an opening, a holding portion defined by the general U-shape, a wall thickness, a first edge and a second edge. There is also a first guide attached to the first edge and a second guide attached to the second edge. The first guide and the second guide are configured to assist placing a component, such as a cord segment, to be held by the first clamp portion into the holding portion and are also configured to provide visual identification of the first clamp portion. The second clamp portion comprises a second generally U-shaped member having an opening, a holding portion defined by the general U-shape, a wall thickness, a first edge and a second edge.

Other embodiments of the present invention are configured to have the first clamp portion hold a component with less force than the second clamp portion when the first and second clamp portions are holding substantially identical components.

Yet other embodiments of the present invention are constructed to be attached to a permanent structure or to a stake utilizing an aperture through the joining structure.

The present invention has advantages over the prior art and makes a technical contribution by providing a low-cost, easily manufactured, and durable cord clip with multiple applications.

### BRIEF DESCRIPTION OF THE DRAWINGS

The present invention is illustrated by way of example, and not by way of limitation in the figures of the accompanying drawings in which like reference numerals refer to similar elements and in which:

FIG. 1 is a perspective view of a preferred embodiment of the present invention.

FIG. 2 is a front view of the embodiment of FIG. 1.

FIG. 3 is a back view of the embodiment of FIG. 1.

FIG. 4 is a right view of the embodiment of FIG. 1.

FIG. 5 is a left view of the embodiment of FIG. 1.

FIG. 6 is a top view of the embodiment of FIG. 1.

FIG. 7 is a bottom view of the embodiment of FIG. 1.

FIG. 8 is a perspective view of the embodiment of FIG. 1 utilized to hold two cord segments.

FIG. 9 is a perspective view of the embodiment of FIG. 1 utilized to keep two cords plugged together.

FIG. 10 is a perspective view of the embodiment of FIG. 1 utilized to hold two cords in a route along a permanent structure.

FIG. 11 is a perspective view of the embodiment of FIG. 1 utilized to hold two cords in a route where there is no permanent structure.

FIG. 12 is a perspective view of the embodiment of FIG. 1 utilized to hold one cord in a route where there is no permanent structure.

### DETAILED DESCRIPTION

The present invention addresses and solves problems related to multipurpose cord clips, such as, but not limited to, retaining multiple cord segments in a fixed relation to one another. The present invention also addresses and solves problems related to retaining single or multiple cords along a route regardless of the presence of a permanent structure.

The present invention solves the above problems by providing a cord clip as discussed below. One of ordinary skill in the art will realize that the following discussion is illustrative and intended to describe preferred embodiments of the present invention and is not intended to limit the present invention to the embodiments discussed. The present invention has numerous applications where a cord clip may be used. The present invention may be scaled and adapted to many applications and is defined by the claims, which set forth the metes and bounds of the present invention.

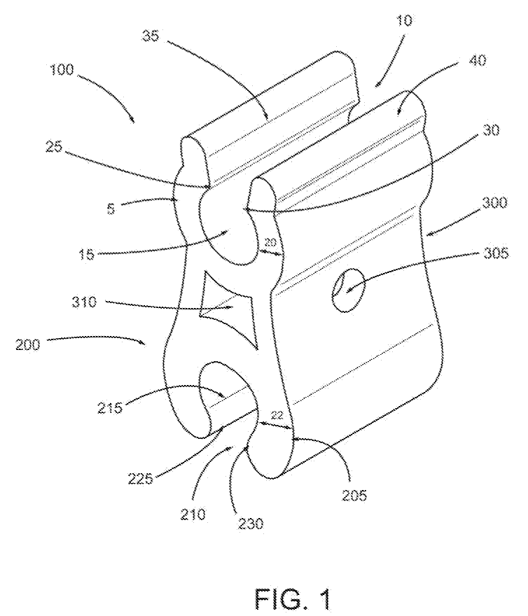

Referring now to the drawings, and initially to FIG. 1, an improved cord clip is described. The preferred embodiment of the inventive cord clip is manufactured from a flexible material such as plastic or rubber. Other materials, for example, but not limited to, metals and resins, can be utilized for the inventive cord clip as long as they provide some flexibility to permit a cord to pass through the openings 10 and 210.

The preferred embodiment comprises a first clamp portion 100 and a second clamp portion 200. The first clamp portion 100 is held in an angular relationship with the second clamp portion 200 by joining structure 300. In the preferred embodiment, the first clamp portion 100, the second clamp portion 200 and the joining structure 300 are made from the same material—preferably in an injection molding process. However, the first clamp portion 100, second clamp portion 200 and joining structure may be made from different materials. Additionally, they may be formed together at once, or may be attached to one another using well known methods such as gluing or welding, for example.

The preferred angular relationship between the first clamp portion 100 and the second clamp portion 200 is to have the openings 10 and 210 disposed 180° from one another—so they are facing in opposite directions. However, it is readily apparent that the openings 10 and 210 can be oriented in any direction and that the joining structure 300 is capable of holding the first clamp portion 100 and the second clamp portion 200 in angular relations other than the one depicted in FIG. 1.

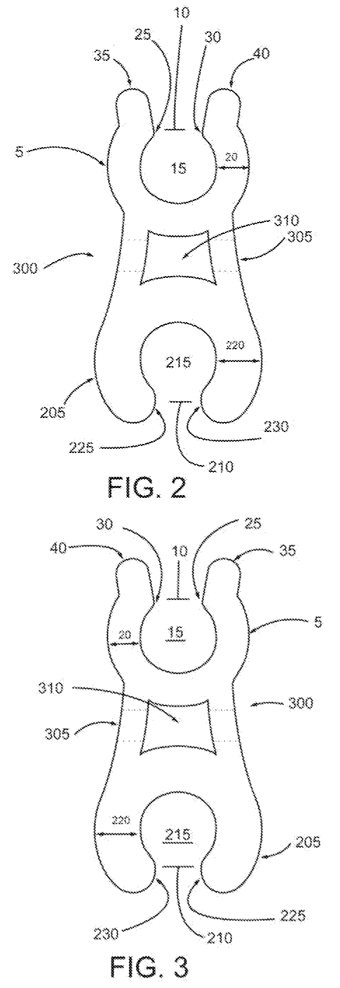

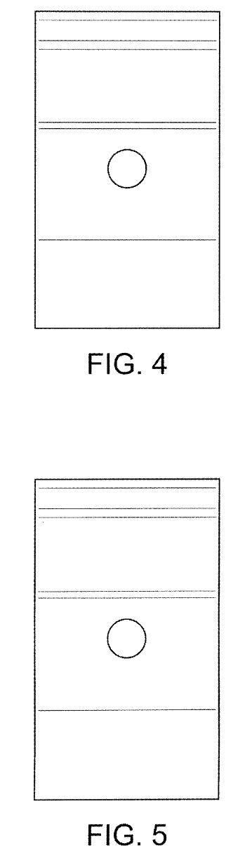

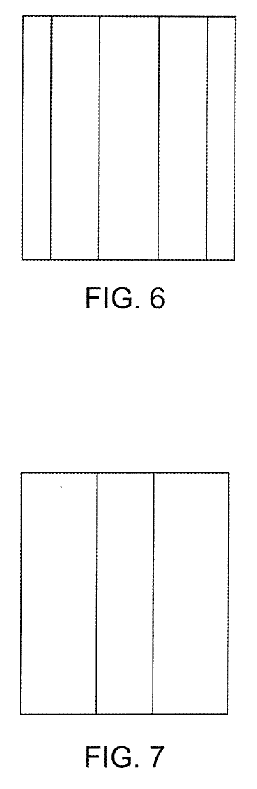

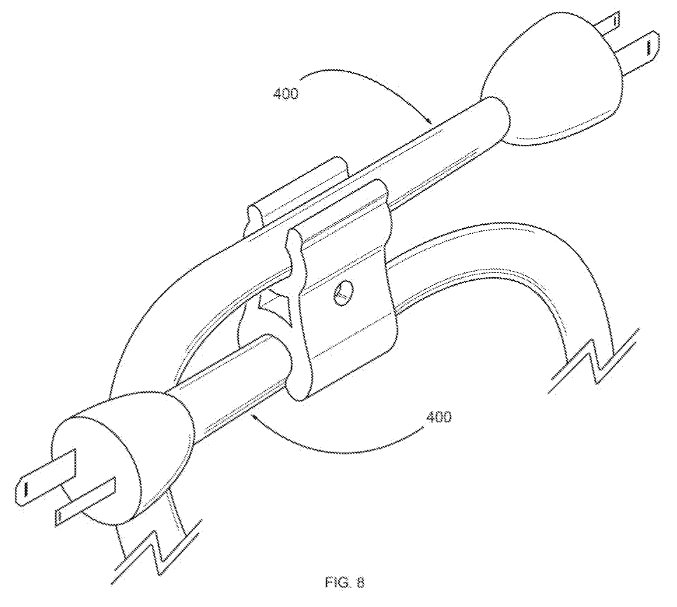

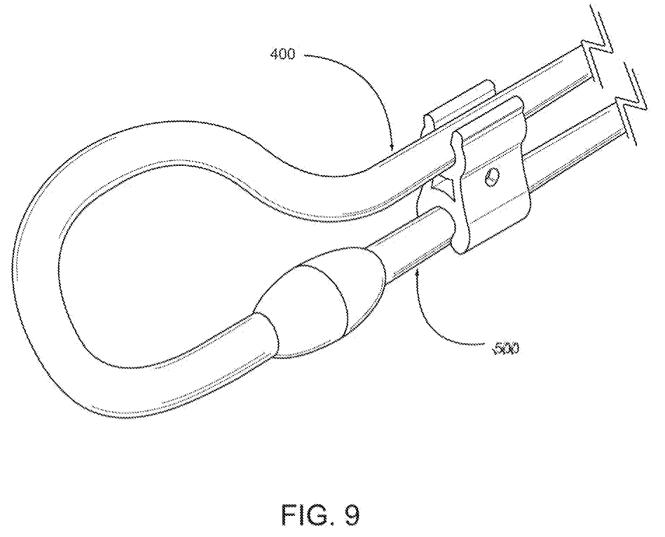

The first clamp portion 100 is made from a generally U-shaped member 5. The general U-shape is best seen from an end view as depicted in FIGS. 2 and 3, and is not strictly limited to the shape of the letter U. The general U-shape of member 5 does not have to be a smooth curve, such as depicted in FIGS. 1-3, but can be any shape configured to retain a cord. A cord typically refers to an electrical cord, but for the purpose of this description includes all elongated members regardless of their construction material or useful purpose.

An opening 10 is defined between the first edge 25 and the second edge 30. The opening 10 is configured to permit a cord to pass into and out of the holding portion 15 in conjunction with the generally U-shaped member 5 flexing as the cord passes between the first edge 25 and the second edge 30. Holding portion 15 is configured to receive a cord—and is sized according to the diameter of the cord desired to be retained in holding portion 15. The opening 10 is sized to permit the cord desired to be retained in holding portion 15 to pass therethrough, but not without the generally U-shaped member 5 flexing to cause the first edge 25 and the second edge 30 to move away from one another.

A first guide 35 is attached to the first edge 25 and a second guide 40 is attached to the second edge 30. In the preferred embodiment, the first guide 35 and the second guide 40 are formed integrally with the first edge 25 and the second edge 30. However, the first guide 35 and the second guide 40 may be created as separate elements and then attached to the first edge 25 and the second edge 30, respectively, by well known methods such as gluing or welding. As depicted in FIGS. 1-3, the first guide 35 and the second guide 40 are attached in a manner which forms a channel into opening 10. The guides 35 and 40 thus help direct a cord desired to be retained in holding portion 15 into the opening 10. The first guide 35 and second guide 40 also provide a visual identification of the first clamp portion 100. As seen in FIGS. 1-3 the first clamp portion 100 is readily discernable from the second clamp portion 200 due to the presence of the guides 35 and 40. It is within the scope of the present invention to have guides similar to 35 and 40—but with differences such as color or shape—attached to the first edge 225 and the second edge 230 of the second clamp portion 200. By differentiating the guides (not shown) attached to the second clamp portion 200 from guides 35 and 40 the visual differentiation between the first clamp portion 100 and the second clamp potion 200 is maintained.

Second clamp portion 200 is constructed similarly to first clamp portion 100 and comprises a generally U-shaped member 205 having a first edge 225 and a second edge 230 which define an opening 210. A holding portion 215 is configured to retain a cord and may be the same size as the holding portion 15, or a different size. In the preferred embodiment depicted in FIGS. 1-3 the wall thickness 20 of the first clamp portion 100 is less than the wall thickness 220 of the second clamp portion. The differential wall thicknesses 20 and 220 provide a stronger holding force by the second clamp portion 200 than what the first clamp portion 100 exhibits. It is also within the scope of the present invention to have the first clamp portion 100 and the second clamp portion 200 exert the same holding force.

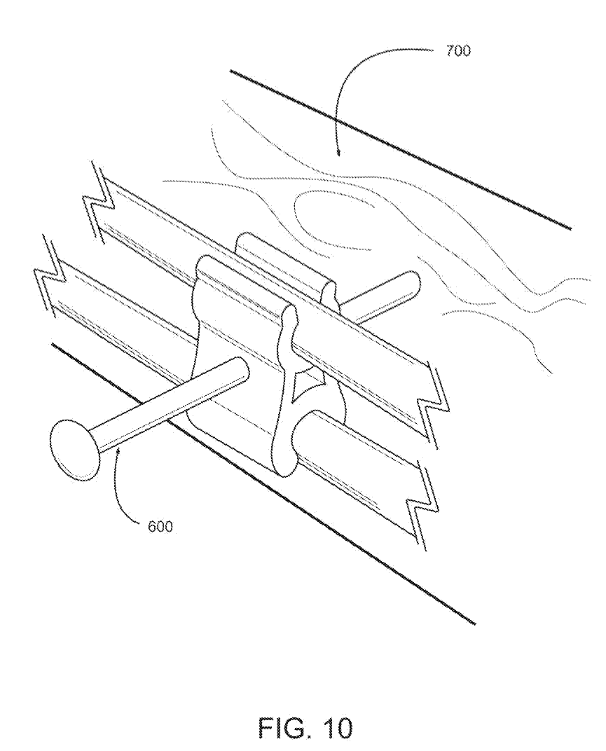

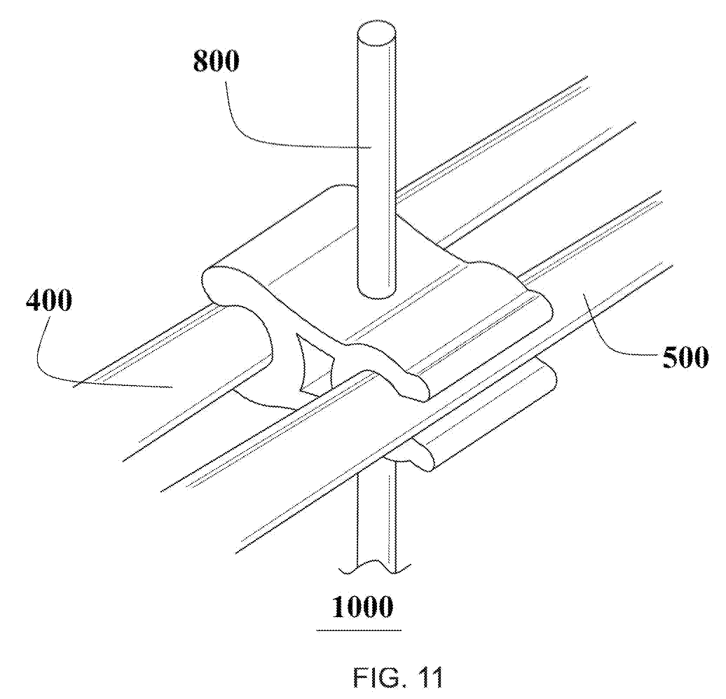

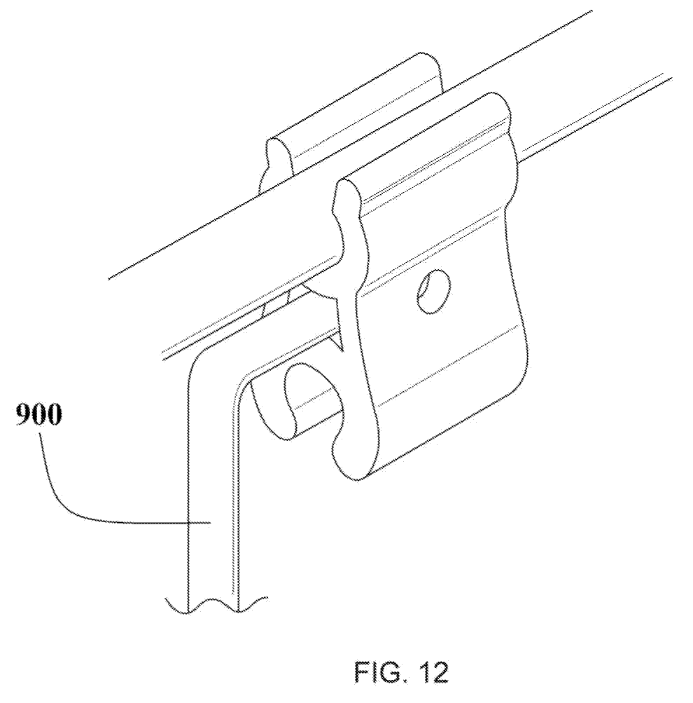

An aperture 305 is made through the joining structure 300 in order to permit the inventive cord clip to be attached to a stake or to a permanent structure for retaining a cord along a route. For example, referring to FIG. 10, a nail 600 passes through aperture 305 and affixes the inventive cord clip to a permanent structure 700, such as a fence, wall, board, floor, etc. A screw, wire tie or other fastener may be used to pass through aperture 305. Referring to FIG. 11, the inventive cord clip is depicted with a stake 800 passing through aperture 305 with an interference fit so that friction between the stake 800 and the walls of aperture 305 prevent the inventive cord clip from sliding along stake 800. Stake 800 is then inserted into the ground 1000 so cords 400 and 500 can run along a route which is above the ground and not attached to any permanent structure. Such an application of the inventive cord clip is useful, for example, to route an electrified wire used to contain animals without grounding the electrified wire or attaching it to a permanent structure such as an existing fence. It is also useful on construction sites to keep electrical cords out of standing water on the ground. Referring to FIG. 12, an alternate manner of attaching a stake 900 to the inventive cord clip utilizes the passage 310.

Referring now to FIGS. 8 and 9, using the inventive cord clip to retain cord segments in a fixed relation to one another is described. In FIG. 8 the cord 400 is coiled for storage. Typically people tie the ends of the cord 400 together or around the coiled cord 400 in order to keep the cord 400 coiled. This is somewhat time consuming and requires that the cord 400 be coiled in a manner where the free ends of the cord 400 are left uncoiled in order to be utilized as ties. The inventive cord clip quickly keeps cord 400 in a coiled condition by simply and easily securing the free ends to the coiled cord 400. If the two free ends are close to one another then only one inventive cord clip is needed, otherwise two can be used to secure the free ends. In FIG. 9 the inventive cord clip is used to retain two cords 400 and 500 in a fixed relation to one another. When extension cords 400 and 500 are plugged together it is common for the plugs to separate as the extension cords 400 and 500 are dragged around and pulled on. To prevent this, many people tie a knot between cords 400 and 500 which results in sharp bends in both cords 400 and 500. This causes unneeded stress on the cords 400 and 500 and increases the electrical resistance due to the sharp bends in cords 400 and 500—which reduces the electrical efficiency of the combined electrical cords 400 and 500. The inventive cord clip is utilized, as depicted in FIG. 9, to keep cord 400 plugged into cord 500. There is only one curve in cord 400 so the electrical resistance of cord 400 is not substantially affected. Any force resulting from pulling the combined cords 400 and 500 along the ground is taken by the inventive clip and not by the plug and socket—resulting in the cords 400 and 500 remaining plugged together.

Alternate manners for varying the clamp force between the first clamp portion 100 and the second clamp portion 200 are within the scope of the present invention. Referring again to FIG. 1 for example, the first edge 25 and the second edge 30 of the first clamp portion 100 can be farther apart than the first edge 225 and the second edge 230 of the second clamp portion 200. Or, the holding portion 15 of the first clamp portion 100 can be larger than the holding portion 215 of the second clamp portion 200. The first clamp portion 100 may be made from a material with a lower Young's Modulus than the material used to make the second clamp portion 200. Young's Modulus is an indication of a material's flexibility. Generally, a material with a lower Young's Modulus is more flexible than a material with a higher Young's Modulus. Young's Modulus is proportional to the material's tensile stress divided by the material's tensile strain. Tensile stress is calculated by dividing the force applied to a material by the cross sectional area through which the force is applied. Tensile strain is calculated by dividing the change in the material's length by the original length of the material. Any of the described manners for varying the holding force of the first clamp portion 100 and the second clamp portion 200 can be utilized singularly or in combination with the other described manners, as well as with other manners which have not been described.

While this invention has been described in connection with what is presently considered to be the most practical and preferred embodiment, it is to be understood that the invention is not limited to the described embodiments, but, on the contrary, is intended to cover various modifications and equivalent arrangements included within the scope of the appended claims.

What is claimed is:

1. A clip comprising:
a first clamp portion;
a second clamp portion; and
a joining structure attached to the first clamp portion and the second clamp potion to hold the first clamp portion in an angular relationship to the second clamp portion;
wherein the first clamp portion comprises:
a first generally U-shaped member having an opening, a holding portion defined by the general U-shape, a wall thickness, a first edge and a second edge;
a first guide attached to the first edge; and
a second guide attached to the second edge;
wherein the first guide and the second guide are configured to assist placing a cord to be held by the first clamp portion into the holding portion and are also configured to provide visual identification of the first clamp portion; and
wherein the second clamp portion comprises a second generally U-shaped member having an opening, a holding portion defined by the general U-shape, a wall thickness, a first edge and a second edge.

2. The clip according to claim 1 wherein there are no guides attached to the first or second edge of the second generally U-shaped member.

3. The clip according to claim 1 further comprising an aperture through the joining structure.

4. The clip according to claim 1 wherein the joining structure is configured to create a passage between the first clamp portion and the second clamp portion.

5. The clip according to claim 1 wherein the first clamp portion is configured to hold a cord with less force than the second clamp portion when the first and second clamp portions are holding substantially identical cords.

6. The clip according to claim 5 wherein the wall thickness of the first generally U-shaped member is less than the wall thickness of the second generally U-shaped member.

7. The clip according to claim 5 wherein the first edge and the second edge of the first generally U-shaped member are farther apart than the first edge and the second edge of the second generally U-shaped member.

8. The clip according to claim 5 wherein the holding portion of the first generally U-shaped member is larger than the holding portion of the second generally U-shaped member.

9. The clip according to claim 5 wherein the first generally U-shaped member is made from a material with a lower Young's Modulus than the material used to make the second generally U-shaped member.

10. The clip according to claim 1 wherein the opening of the first generally U-shaped member is configured to face 180° in the opposite direction from the opening of the second generally U-shaped member.

11. A clip comprising:
a first clamp portion;
a second clamp portion; and
a joining structure attached to the first clamp portion and the second clamp potion to hold the first clamp portion in an angular relationship to the second clamp portion and having an aperture therethrough;
wherein the first clamp portion comprises:
a first generally U-shaped member having an opening, a holding portion defined by the general U-shape, a wall thickness, a first edge and a second edge;
a first guide attached to the first edge; and
a second guide attached to the second edge;
wherein the first guide and the second guide are configured to assist placing a cord to be held by the first clamp portion into the holding portion and are also configured to provide visual identification of the first clamp portion; and
wherein the second clamp portion comprises a second generally U-shaped member having an opening, a holding portion defined by the general U-shape, a wall thickness, a first edge and a second edge; and
wherein the first clamp portion is configured to hold a cord with less force than the second clamp portion when the first and second clamp portions are holding substantially identical cords.

12. A clip comprising:
a first clamp portion;
a second clamp portion; and
a joining structure attached to the first clamp portion and the second clamp potion to hold the first clamp portion in an angular relationship to the second clamp portion;
wherein the first clamp portion comprises:
a first generally U-shaped member having an opening, a holding portion defined by the general U-shape, a wall thickness, a first edge and a second edge;
a first guide attached to the first edge; and
a second guide attached to the second edge;
wherein the first guide and the second guide are configured to assist placing a cord to be held by the first clamp portion into the holding portion and are also configured to provide visual identification of the first clamp portion; and
wherein the second clamp portion comprises a second generally U-shaped member having an opening, a holding portion defined by the general U-shape, a wall thickness, a first edge and a second edge; and
wherein the first clamp portion is configured to hold a cord with less force than the second clamp portion when the first and second clamp portions are holding substantially identical cords due to the wall thickness of the first generally U-shaped member being less than the wall thickness of the second generally U-shaped member.
